(19) United States
(12) Patent Application Publication
(10) Pub. No.: US 2001/0043226 A1
(43) Pub. Date: Nov. 22, 2001

(54) FILTER BETWEEN GRAPHICS ENGINE AND DRIVER FOR EXTRACTING INFORMATION

(76) Inventors: ROELJAN VISSER, CUPERTINO, CA (US); GUY BAR-NAHUM, PALO ALTO, CA (US)

Correspondence Address: CORPORATE PATENT COUNSEL, U S PHILIPS CORPORATION, 580 WHITE PLAINS ROAD, TARRYTOWN, NY, 10591

(21) Appl. No.: 08/972,511

(22) Filed: Nov. 18, 1997

(51) Int. Cl. G09G 5/36

(52) U.S. Cl. 345/581

(57) ABSTRACT

An image processing system has a computer coupled to a display device. The display has a screen for display of graphics data. The computer has an interface between its graphics engine and the driver of the display device. The interface selectively extracts specific information, e.g., with respect to screen locations, from the function calls issued by the engine. The interface enables modifying the function calls based on the information extracted, prior to delivery to the driver.

### FIELD OF THE INVENTION

The invention relates to a data processing system that comprises a computer and a display coupled to the computer for the display of graphics data, and to a method of communicating graphics data over a digital communication medium.

### BACKGROUND ART

A display is an electronic device for presenting information in a visual form. A bit-mapped display is a display wherein each pixel is individually addressable independently of other pixels. A typical example of a bit-mapped display is a VGA monitor provided with a VGA card.

U.S. Pat. No. 4,958,378, herewith incorporated by reference, discloses a system for controlling a VGA monitor. The system has a PC and a video adaptor interfacing commands, issued by the PC, to the monitor. A raster image in the display's frame buffer is compared to an updated raster image and the data changes are noted on a pixel-by-pixel basis. Utilizing the information gathered on the changed pixels, the video display need only update the changed data, thereby minimizing the amount of data to be transferred to the VGA card of the receiving monitor.

The known system employs two memories to control the data update. A first memory stores the current state of the pixel-content of the display. New data and a particular address are supplied to the first memory. The new data are also supplied to a first input of an XOR logic gate. A second input of the XOR gate receives the current data occupying the memory location at the particular address. The XOR logic gate serves as a difference detector. Upon a detecting a difference, i.e., an update, the new data is written to the first memory at the particular address, and the address of the update is stored in a second memory under control of the output of the XOR. The addresses written to the second memory thus identify the updates that need to be transmitted next to the frame buffer of the display.

### OBJECT OF THE INVENTION

The known system employs additional hardware to identify update pixels at the level of the frame buffer and communicates those updates to save on bandwidth. It is an object of the invention to provide a software solution to identify screen updates.

### SUMMARY OF THE INVENTION

To this end, the invention provides a data processing system that comprises a data processing apparatus for generating graphics data. The apparatus has a graphics engine. The system further comprises a display device coupled to the apparatus and having a screen for display of the data. The system also comprises a display driver for driving the device, and an interface between the engine and the driver for selectively extracting, from a function call from the engine to the driver, information for control of the driver.

A graphics engine conventionally supplies control signals to the driver to update the screen content upon a request from a software application running on the data processing apparatus. The driver thereupon renders the object specified in the request. The control signals determine the location on the screen and color (or gray level) of the update. Accordingly, the information about the location of the update on the screen is already available in the graphics engine. A graphics engine and a display driver are located conventionally together on the same machine. The engine issues function calls to the driver that the driver can recognize. In the invention, an interface is located between the engine and the driver to extract the information about an updatable screen area. This interface makes it possible to have the driver and the engine located on different machines interconnected via a network. The engine needs an on-site representative of the remote driver with which it is capable of communicating. The representative, referred to above as the interface, mimics the driver so that the engine communicates to the interface as if it were the driver. The interface covers the interface functionalities of the remote driver. Now, the high-level calls are routed over the network to the remote driver and take effect at the remote location. The interface is a piece of software, e.g., integrated in the kernel of the operating system of the data processing apparatus, e.g., PC. Alternatively, or supplementarily, the interface makes it possible to monitor the function calls from the engine to the driver, to analyze the calls in order to extract information about the scope of the calls and to process the information prior to its being forwarded to the driver, whether the engine is located on the same machine as the driver or on a different machine than the driver. For example, the information supplied to the driver can be modified, e.g., to reduce Moiré patterns or to enhance the brightness of a particular window area on the screen. As another example, assume that the graphics engine comprises a rendering engine such as Direct3D of Microsoft. Direct3D is a complete set of real-time 3D graphics services that deliver fast software-based rendering of the full 3D rendering pipeline (transformations, lighting, and rasterization), transparent access to hardware acceleration and a comprehensive, next-generation 3D solution for a PC (source: http://www.metavr.com/direct3d.htm). Assume further that the interface extracts information from the function calls to the driver about an object to be displayed. Next, this information is modified by creating two stereoscopically related versions of the original object and passed on to the OEM driver that controls two separate displays, e.g., mounted in a head-mounted display. Accordingly, stereoscopic images are created simply by having the interface interfering with the communication from the engine to the driver.

### BRIEF DESCRIPTION OF THE DRAWINGS

The invention is further explained by way of example and with reference to the accompanying drawings, wherein:

FIG. 1 is a block diagram of a conventional data processing system;

FIG. 2 is a first block diagram of a data processing system of the invention; and

FIG. 3 is a second block diagram of a data processing system of the invention.

Throughout the figures, same reference numerals indicate similar or corresponding features.

### PREFERRED EMBODIMENTS

Conventional System

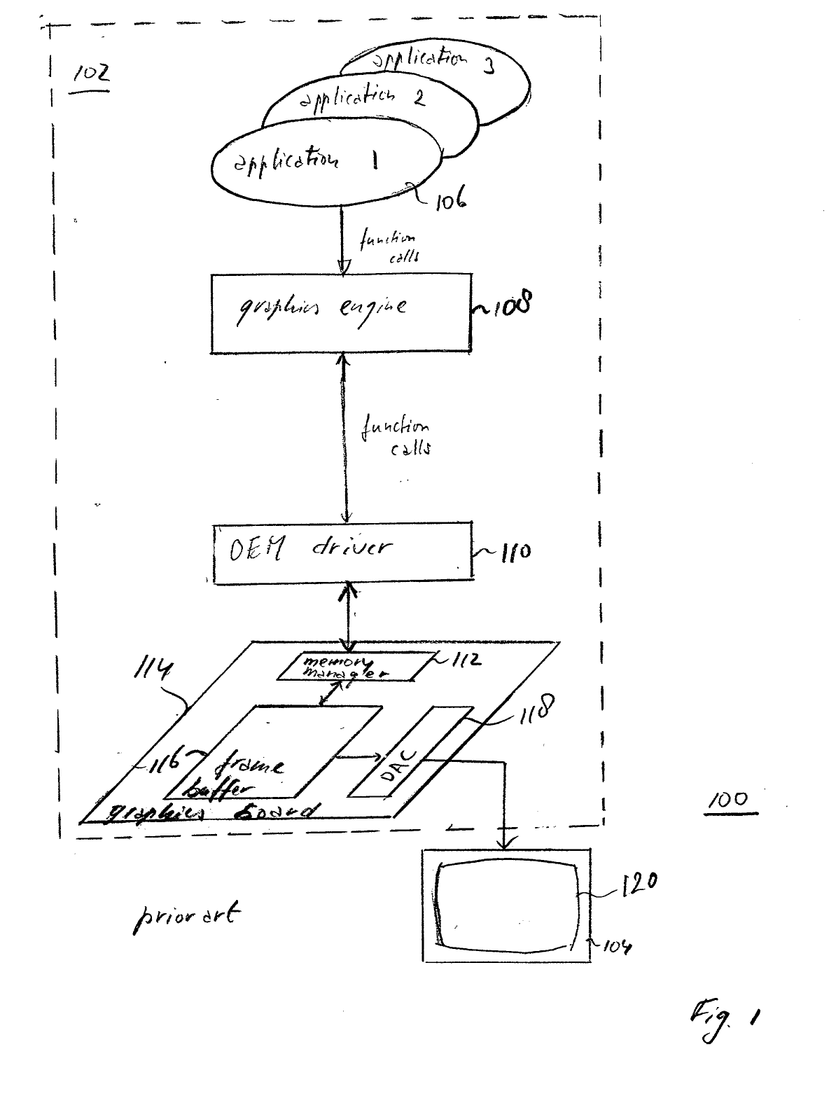

FIG. 1 is block diagram of a conventional data processing system 100. System 100 comprises a host computer 102, e.g., a PC or a multi-client server, for supply of graphics data. Computer 102 is connected to a display device 104, here a CRT. Computer 102 runs a software application, e.g., application 106. Application 106 sends graphics requests in a high-level graphics language to a graphics engine 108. Graphics engine 108 translates high-level graphics concepts such as geometrical shapes into function calls to display driver 110. Graphics engines are known, e.g., from U.S. Pat. No. 5,321,805 herein incorporated by reference. Driver 110 translates the calls into data for a memory manager 112 on a graphics board 114. Memory manager 112 writes the data to a frame buffer 116 and reads data from buffer 116. A DAC 118 on graphics board 116 converts the digital information in buffer 114 into an analog control signal for control of local display device 104. Display device 104 then displays the graphics information on its screen 120.

There is a one-to-one correspondence between an address of a memory location in buffer 116 and a location on screen 120 of local display device 104. The data content of buffer 116 represents the current data content of the image on screen 120. The function calls to driver 110 involve information as to the locations on screen 120 that are subject to an update. In other words, the spatial characteristics of the screen update are already available in graphics engine 108. Graphics engine 108 supplies information that therefore identifies a specific portion of the area of screen 120 whose graphics data content is subject to change. The data representing the change is transferred to buffer 116 for locally updating its content and, therefore, that of screen 120.

First Block Diagram of System of the Invention

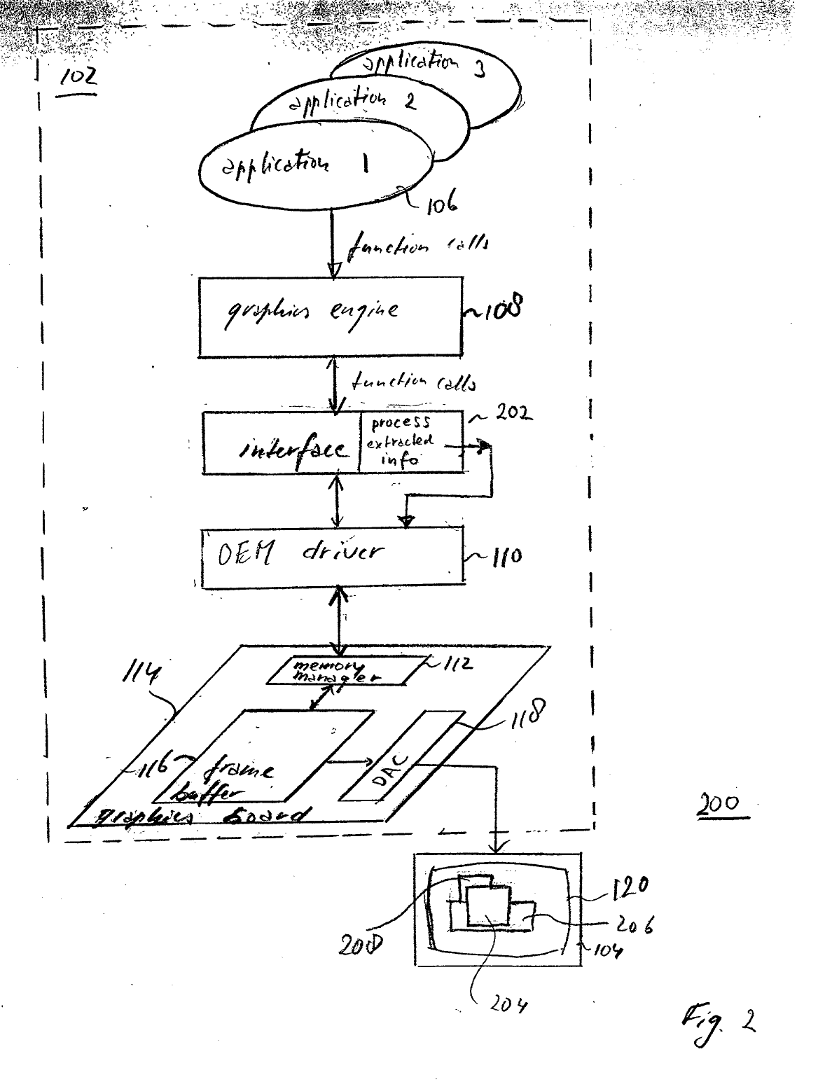

FIG. 2 is a first block diagram with the main components of a first example of a system 200 according to the invention. The invention adds an interface 202 between engine 108 and driver 110. Interface 202 selectively extracts information from the communication from engine 108 to driver 110 regarding a particular area of the screen while mimicking driver 110 toward engine 108 and while mimicking engine 108 toward driver 110. Interface 202 communicates with engine 108 as if it were driver 110, and with driver 110 as if it were engine 108. The invention is based on the insight that all the information about the next update is already available in graphics engine 108 in a high-level graphics language. Interface 202 is capable of monitoring the passage of function calls between engine 108 and driver 110 regarding those updates. Upon intercepting an update with respect to a particular area of screen 120, interface 202 modifies this update and passes on the modified update to driver 110. In this manner, interface 202 adds an additional layer of processing and makes it possible to process the extracted information beyond the capability of driver 110. This feature can be used, for example, to reduce Moiré patterns in the eventual image on screen 120 by appropriate filtering, e.g., by having driver 110 spreading the pixel information over a larger area, or to enhance the brightness of a particular window 204 on screen 120 and to reduce the brightness of other windows 206 and 208.

Second Block Diagram of a System in the Invention

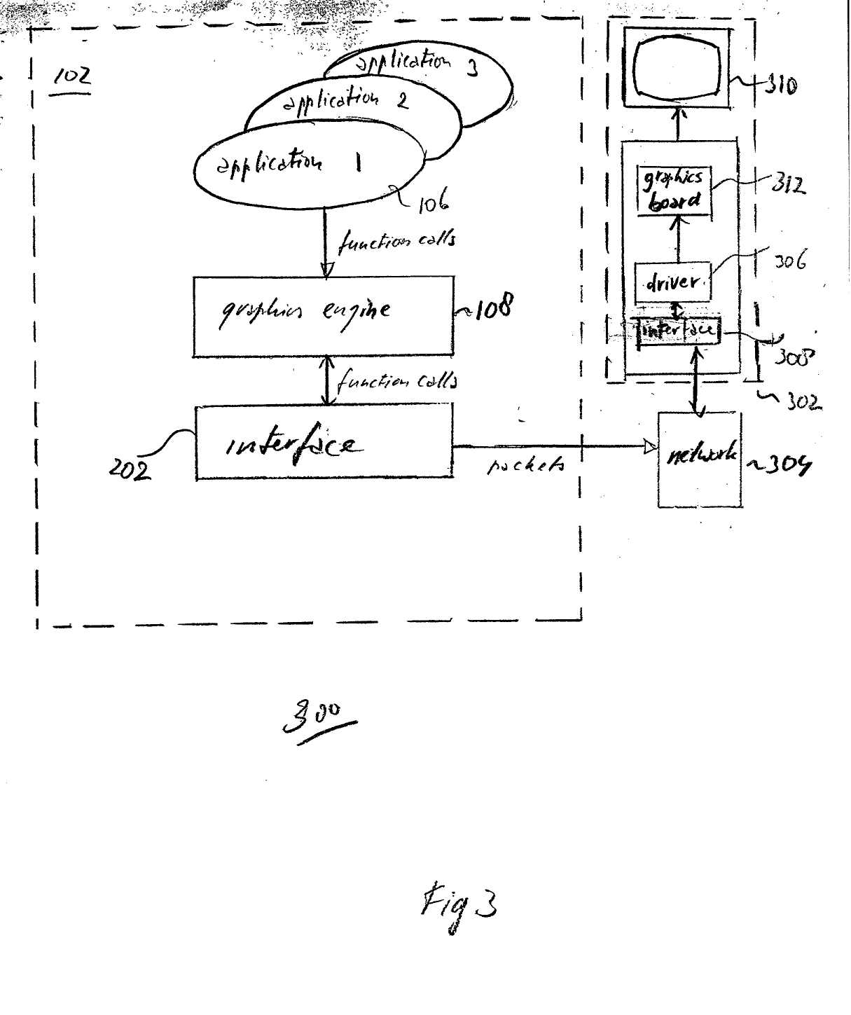

FIG. 3 is a block diagram with the main components of a second example of a system 300 according to the invention. In system 300, computer 102 is coupled to a remote client 302 via a network 304. More specifically, graphics engine 108 is coupled to a display driver 306 of remote client 302 via interface 202 and an interface 308. Interface 202 resides at computer 102, and interface 308 resides at client 302. Information is extracted from graphics engine 108 via interface 202 for being transferred to remote client 302. Display driver 306 is coupled to a display device 310 via a graphics board 312. Board 312 has a configuration, for example, similar to board 114 in system 100. The information supplied by engine 108 is in a high-level graphics language and is, therefore, independent of the actual format of the data that driver 306 is capable of supplying. The only requirement is that engine 108 supports the translation from the high-level language to the signals used by driver 306.

Interface 202 has several functions in the system configuration of system 300. Interface 202 serves as an information routing device for routing data to driver 306. It further represents driver 306 at computer 102 and mimics its behavior as far as the interaction with engine 108 is concerned. That is, interface 202 is capable of processing the function calls it receives from engine 108 and of passing them on to driver 306. Similarly, client 302 has an interface 308 between driver 306 and network 304. Interface 308 serves to represent engine 108 at remote client 302 by accepting function calls made by driver 306 to engine 108 and passing them on over network 304. Interface 202 supplies packages to interface 308 that client 302 decodes back to video data. Interface 308 is a communication layer that accepts the package from network 304, decodes the package and calls the appropriate driver function that corresponds to the original request from engine 108.

The information about the affected screen areas is passed over network 304 to remote client 302. Client 302 updates the affected areas upon receipt of the new information. If there are no display changes, the network bandwidth used is nil.

Apart from providing a software solution to the bandwidth problem, discussed above, the invention also enables to interfere with the communication between graphics engine 108 on the one hand, and local display driver 306 on the other hand. For example, undesired image artifacts (e.g., a Moiré pattern on the screen of display 310) can be prevented or made less noticeable by having interfaces 202 or 308 pre-processing the calls from engine 108 to driver 306. In case of the Moiré pattern, interface 202 is capable of filtering operations, e.g., by having driver 306 spreading the pixel information over a larger area.

Nowadays, the processing power of a desktop computer provided with multiple digital displays and a multi-user operating system can easily accommodate several users with no observable penalty to the individual user on most software applications. In the home, a multiple display capability adds to the user-friendliness by way of enabling visual access from different places. System 300 is an example of such a configuration when more than one client is connected to computer 102 via network 304. In that case, host 102 has an operating system that can service multiple clients (e.g., Windows 98 of Microsoft). Interface 202 then creates information packets for each individual one of multiple clients, among which is client 302, and sends the packets via network 304 to the appropriate client.

The term “graphics data” within this context covers graphics information as a bit-map file, a vector file, a PDL file, or a VRML file, the arguments in the graphics-engine/display-driver interface calls, etc., or combinations thereof. A bit-map file contains graphics information described as pixels. A vector file contains data described in terms of mathematical equations. Page Description Languages (PDL) are used to describe the layout of a printed page of graphics and text. Multi-dimensional-object formats store graphics data as a collection of data and code that manipulates the data so that the object represented may be rendered in a variety of perspectives. Virtual Reality Modeling Language (VRML) is a 3D, object-oriented language for describing virtual environments for multiple-user applications. The arguments in the graphics-engine/display-driver interface calls hold the description of the graphics operation requested.

We claim:

1. A data processing system comprising:
a data processing apparatus for generating graphics data and having a graphics engine;
a display device coupled to the apparatus and having a screen for display of the data;
a display driver for driving the device; and
an interface between the engine and the driver for selectively extracting, from a function call from the engine to the driver, information for further control of the driver.

2. The system of claim 1, wherein the information relates to the data associated with a specific area of the screen.

3. The system of claim 1, wherein the extraction is programmable with regard to location on the screen.

4. The systems of claim 1, wherein:
the system comprises a network for connecting the apparatus and the display device;
the interface is accommodated in the apparatus;
the driver is accommodated in the display device; and
the interface communicates the information over the network to the driver.

5. The system of claim 4, wherein the display device has a further interface for enabling communication via the network from the driver to the engine.

6. The system of claim 1, wherein the interface selectively modifies the information for modifying the function call prior to delivery to the driver.

7. The system of claim 6, wherein
the interface is accommodated in the apparatus; and
the driver is accommodated in the apparatus.

8. A method of communicating information from a graphics engine to a display driver, the method comprising extracting specific information from a function call from the engine to the driver, for further control of the driver.

9. The method of claim 8, comprising modifying the function call based on the specific information prior to delivery to the driver.

10. The method of claim 8, comprising transferring the specific information over a network to the driver.

11. A data processing apparatus for generating graphics data, the apparatus having:
a graphics engine; and
an interface for selectively extracting information from a function call issued by the engine.

12. A display device comprising:
a screen for display of graphics data;
a display driver for driving the device; and
an interface for representing a graphics engine with respect to the driver.
